(19) United States
(12) Patent Application Publication
(10) Pub. No.: US 2015/0295964 A1
(43) Pub. Date: Oct. 15, 2015

(54) METHODS AND SYSTEMS FOR CONDUCTING AN ELECTRONIC DEVICE ENHANCED MEETING

(71) Applicant: Brian S. Probolsky, Laguna Niguel, CA (US)

(72) Inventor: Brian S. Probolsky, Laguna Niguel, CA (US)

(21) Appl. No.: 14/682,505

(22) Filed: Apr. 9, 2015

Related U.S. Application Data
(60) Provisional application No. 61/977,489, filed on Apr. 9, 2014.

(51) Int. Cl. H04L 29/06; H04L 29/08

(52) U.S. Cl. CPC H04L 65/4038; H04L 67/10

(57) ABSTRACT

Methods for conducting an electronic device enhanced meeting using an electronic computing device are presented including: causing the electronic computing device to create the electronic device enhanced meeting; selecting meeting attributes for the electronic device enhanced meeting; selecting participants for the electronic device enhanced meeting; selecting participant attributes for the electronic device enhanced meeting; and conducting the electronic device enhanced meeting. In some embodiments, selecting meeting attributes for the electronic device enhanced meeting further includes: selecting a meeting type; and setting default meeting attributes, where the default meeting attributes are selected from the group consisting of: agenda attributes, speaker attributes, meeting security attributes, listing attributes, invite attributes, motion rights attributes, voting rights attributes, and chat attributes.

### FIELD OF INVENTION

Embodiments of the present invention relate generally to utilizing electronic devices to create and conduct meetings.

### BACKGROUND

The widespread proliferation of electronic devices has opened new and different ways for users to interact. In addition, meetings are a modern fact of life that require discipline and organization to conduct properly. Until now, electronic devices have tended either to serve a minor role as a storage device for a meeting, or have been incorporated into cumbersome installed systems to conduct meetings. However, as the power and utility of portable electronic devices have increased, it makes sense to utilize modern tools to make meetings more effective without the necessity of installed systems or without relegating such powerful devices to a mere recording device. As such, methods and systems for conducting electronic device enhanced meetings are presented herein.

### BRIEF SUMMARY

The following presents a simplified summary of some embodiments of the invention in order to provide a basic understanding of the invention. This summary is not an extensive overview of the invention. It is not intended to identify key/critical elements of the invention or to delineate the scope of the invention. Its sole purpose is to present some embodiments of the invention in a simplified form as a prelude to the more detailed description that is presented below.

As such, methods for conducting an electronic device enhanced meeting using an electronic computing device are presented including: causing the electronic computing device to create the electronic device enhanced meeting; selecting meeting attributes for the electronic device enhanced meeting; selecting participants for the electronic device enhanced meeting; selecting participant attributes for the electronic device enhanced meeting; and conducting the electronic device enhanced meeting. In some embodiments, selecting meeting attributes for the electronic device enhanced meeting further includes: selecting a meeting type; and setting default meeting attributes, where the default meeting attributes are selected from the group consisting of: agenda attributes, speaker attributes, meeting security attributes, listing attributes, invite attributes, motion rights attributes, voting rights attributes, and chat attributes. In some embodiments, selecting meeting attributes for the electronic device enhanced meeting further includes: selecting agenda attributes; selecting speaker attributes; selecting meeting security attributes; and selecting listing attributes. In some embodiments, selecting meeting attributes for the electronic device enhanced meeting further includes: selecting invite attributes, where the invite attributes include invited participants and non-invited participants; selecting motion rights attributes; selecting voting rights attributes; and selecting chat attributes. In some embodiments, the meeting type includes: a parliamentary procedure supported meeting, a roundtable meeting, a board meeting, a committee meeting, a teleconference meeting, a lecture meeting, a sporting event, and a concert. In some embodiments, the meeting security attributes for the electronic device enhanced meeting include: a private meeting attribute, a public meeting attribute, a geographically defined meeting attribute, a third party authenticated meeting attribute, an organizationally defined meeting attribute, a viewing only meeting attribute, a password protected meeting attribute, and a hardware secured meeting attribute. In some embodiments, participant attributes of non-invited participants may be dynamically and individually modified during the electronic device enhanced meeting.

In some embodiments, selecting participant attributes for the electronic device enhanced meeting further includes: selecting a participant level; selecting participant motion rights; selecting participant voting rights; selecting participant interrupt privileges; selecting participant limitations; selecting participant display name; and selecting participant display image. In some embodiments, the participant attributes for the electronic device enhanced meeting may be dynamically and individually modified during the electronic device enhanced meeting. In some embodiments, conducting the electronic device enhanced meeting further includes: running the agenda; and automatically updating and displaying minutes in response to actions associated with running the agenda.

In other embodiments, computing device program products for conducting an electronic device enhanced meeting using a computing device are presented including: a non-transitory computer readable medium; first programmatic instructions for creating the electronic device enhanced meeting where the programmatic instructions are stored on the non-transitory computer readable medium; second programmatic instructions for selecting meeting attributes for the electronic device enhanced meeting; third programmatic instructions for selecting participants for the electronic device enhanced meeting; fourth programmatic instructions for selecting participant attributes for the electronic device enhanced meeting; and fifth programmatic instructions for conducting the electronic device enhanced meeting. In some embodiments, selecting meeting attributes for the electronic device enhanced meeting further includes: sixth programmatic instructions for selecting a meeting type; and seventh programmatic instructions for setting default meeting attributes, where the default meeting attributes include at least agenda attributes, speaker attributes, meeting security attributes, listing attributes, invite attributes, motion rights attributes, voting rights attributes, and chat attributes. In some embodiments, the second programmatic instructions for selecting meeting attributes for the electronic device enhanced meeting further includes: eighth programmatic instructions for selecting meeting security attributes, where the meeting security attributes for the electronic device enhanced meeting are selected from the group consisting of: a private meeting attribute, a public meeting attribute, a geographically defined meeting attribute, a third party authenticated meeting attribute, an organizationally defined meeting attribute, a viewing only meeting attribute, a password protected meeting attribute, a software secured meeting attribute, and a hardware secured meeting attribute. In some embodiments, the participant attributes for the electronic device enhanced meeting may be dynamically and individually modified during the electronic device enhanced meeting. In some embodiments, the fifth programmatic instructions for conducting the electronic device enhanced meeting further includes: ninth programmatic instructions for running the agenda; and tenth programmatic instructions for automatically updating and displaying minutes in response to actions associated with running the agenda. In some embodiments, the conducting the electronic device enhanced meeting further includes: eleventh programmatic instructions for processing a motion; twelfth programmatic instructions for processing a vote; thirteenth programmatic instructions for processing an interruption; and fourteenth programmatic instructions for modifying a participant.

### BRIEF DESCRIPTION OF THE SEVERAL VIEWS OF THE DRAWINGS

The present invention is illustrated by way of example, and not by way of limitation, in the figures of the accompanying drawings and in which like reference numerals refer to similar elements and in which:

FIG. 1 is an illustrative representation of a system for conducting an electronic device enhanced meeting using an electronic computing device in accordance with embodiments of the present invention;

FIG. 2 is an illustrative flowchart of a meeting process utilizing methods for conducting an electronic device enhanced meeting using an electronic computing device in accordance with embodiments of the present invention;

FIG. 3 is an illustrative flowchart of organizing a meeting utilizing methods for conducting an electronic device enhanced meeting using an electronic computing device in accordance with embodiments of the present invention;

FIG. 4 is an illustrative flowchart of establishing meeting attributes utilizing methods for conducting an electronic device enhanced meeting using an electronic computing device in accordance with embodiments of the present invention;

FIG. 5 is an illustrative flowchart of establishing participant attributes utilizing methods for conducting an electronic device enhanced meeting using an electronic computing device in accordance with embodiments of the present invention; and

FIG. 6 is an illustrative flowchart of running a meeting utilizing methods for conducting an electronic device enhanced meeting using an electronic computing device in accordance with embodiments of the present invention.

### DETAILED DESCRIPTION

As will be appreciated by one skilled in the art, the present invention may be a system, a method, and/or a computer program product. The computer program product may include a computer readable storage medium (or media) having computer readable program instructions thereon for causing a processor to carry out aspects of the present invention. The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing.

A computer readable storage medium, as used herein, is not to be construed as being transitory signals/per se/, such as radio waves or other freely propagating electromagnetic waves, electromagnetic waves propagating through a waveguide or other transmission media (e.g., light pulses passing through a fiber-optic cable), or electrical signals transmitted through a wire. Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device. Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions. These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks. The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks. The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide processes for implementing the functions/acts specified in the flowchart and/or block diagram block or blocks.

The terms “certain embodiments”, “an embodiment”, “embodiment”, “embodiments”, “the embodiment”, “the embodiments”, “one or more embodiments”, “some embodiments”, and “one embodiment” mean one or more (but not all) embodiments unless expressly specified otherwise. The terms “including”, “comprising”, “having” and variations thereof mean “including but not limited to”, unless expressly specified otherwise. The enumerated listing of items does not imply that any or all of the items are mutually exclusive, unless expressly specified otherwise. The terms “a”, “an” and “the” mean “one or more”, unless expressly specified otherwise.

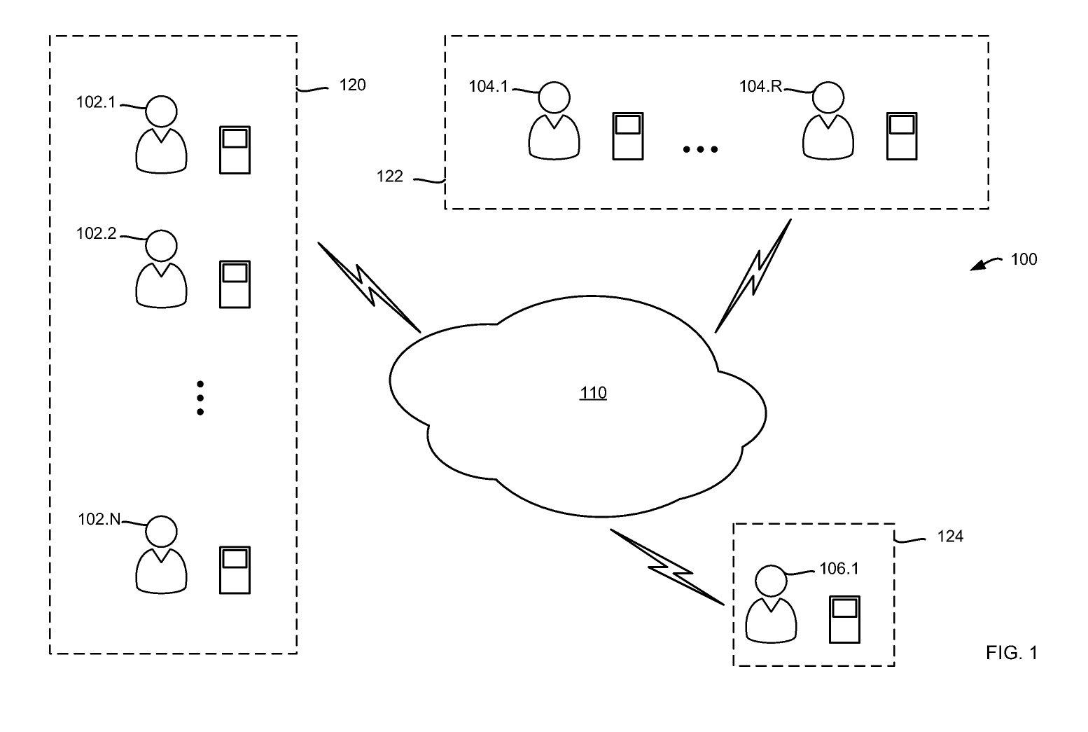

FIG. 1 is an illustrative representation of a system 100 for conducting electronic device enhanced meetings using an electronic computing device in accordance with embodiments of the present invention. As illustrated, a number of participants having electronic devices may participate in an electronic device enhanced meeting. For example, a number of participants 102.1, 102.2 . . . 102.N each having electronic devices may attend an electronic device enhanced meeting in the same geographic location 120. In some embodiments, a number of additional participants 104.1 . . . 104.R each having electronic devices may attend the electronic device enhanced meeting in a different geographic location 122. These participants may “connect” with the meeting via a wired or unwired network or cloud 110. In addition, another participant 106.1 having an electronic device may attend the electronic device enhanced meeting in yet another geographic location 124. This participant may “connect” with the meeting via a wired or unwired network or cloud 110. As may be appreciated, although “geographic locations” are indicated, the delineations may be characterized in other manners. For example a group may be organizationally delineated in the same or different geographic locations. Other delineations may be defined by participant level or class. Importantly, any grouping, whether local or remote, may be accomplished utilizing methods provided herein. In addition, any suitable electronic device may be utilized without limitation as methods provided may be practiced and optimized for any device. That is, methods provided may be device independent.

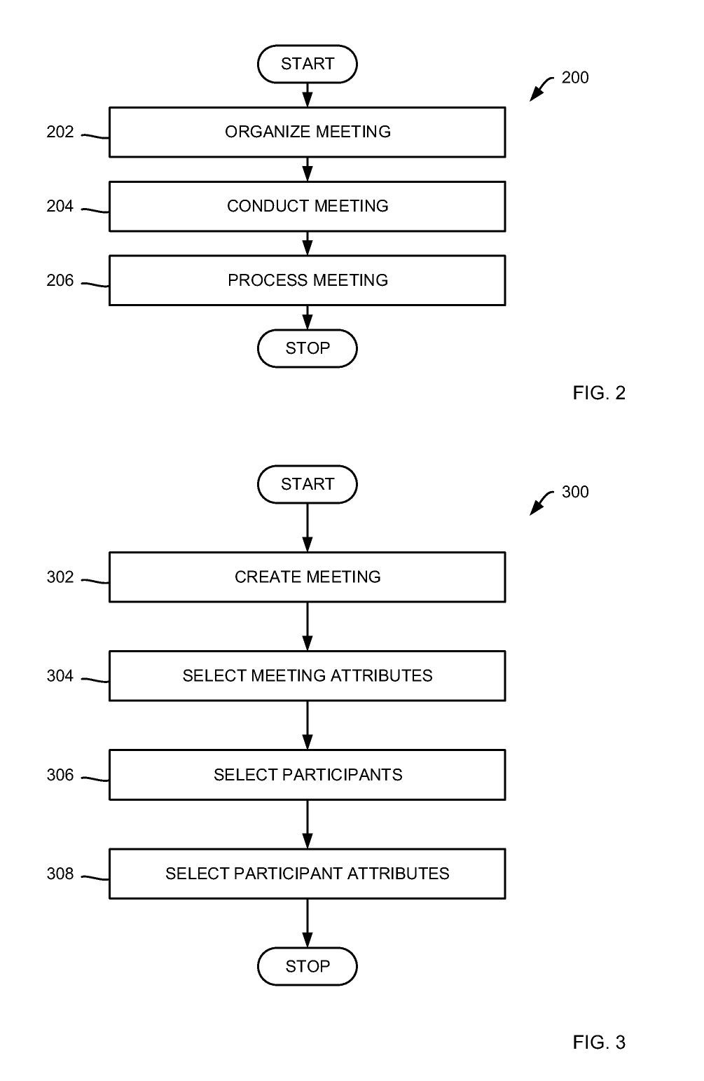

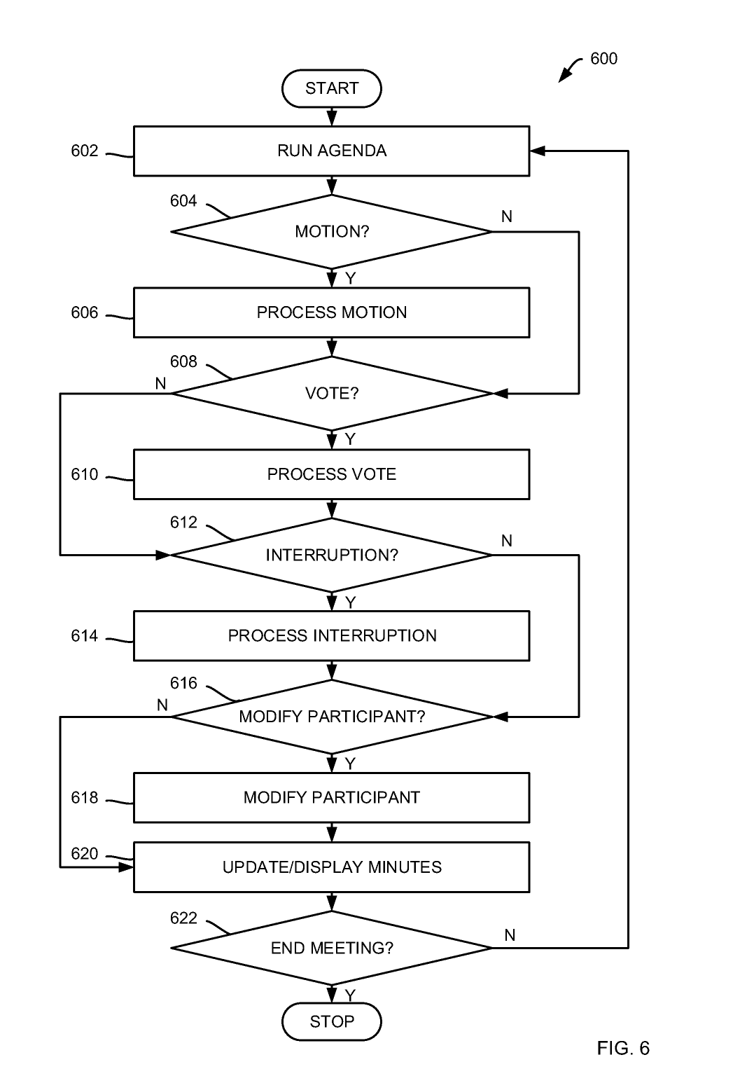

FIG. 2 is an illustrative flowchart 200 of a meeting process utilizing methods for conducting an electronic device enhanced meeting using an electronic computing device in accordance with embodiments of the present invention. In general, a meeting includes at least three separate phases: organizing the meeting, conducting the meeting, and processing the meeting. As illustrated, at a step 202, a user or participant may organize a meeting. In embodiments, a meeting may be organized by establishing meeting attributes and participant attributes which will be discussed in further detail below for FIGS. 3-5. A meeting may be broadly defined as a gathering of two or more participants for an exchange of information. The participants may be in local or remote contact and the meeting may take the form of any number of types from a formalized board meeting to a recital or concert. It is not intended that the term meeting be limited to any one definition or construction. At a next step 204, a user or participant may conduct the meeting. Embodiments provided herein allow a meeting to be enhanced by automated or semi-automated functions. Methods for conducting a meeting and associated functionality will be discussed in further detail below for FIG. 6. Once a meeting is completed at a step 206, a user or participant may then process the meeting. In conventional systems, processing a meeting may include writing and distributing minutes. In present embodiments, much of the conventional processing occurs automatically or semi-automatically. For example, in embodiments, minutes may be automatically processed and displayed while a meeting proceeds so that by the end of the meeting, all participants may immediately have a record of the meeting.

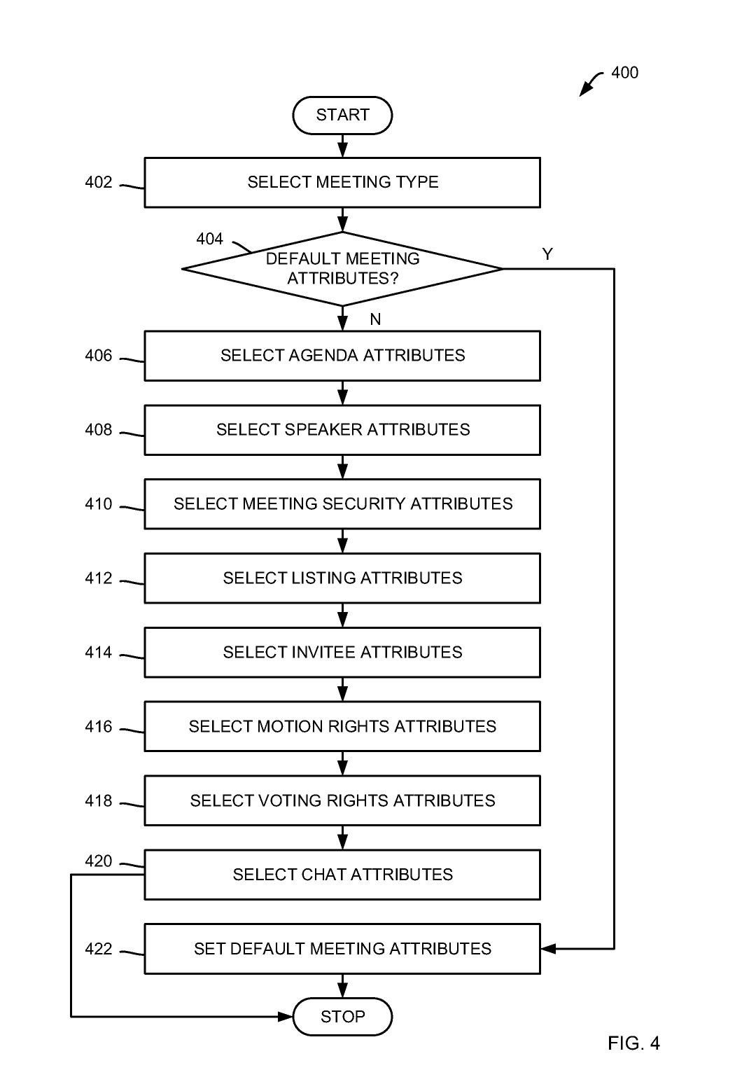

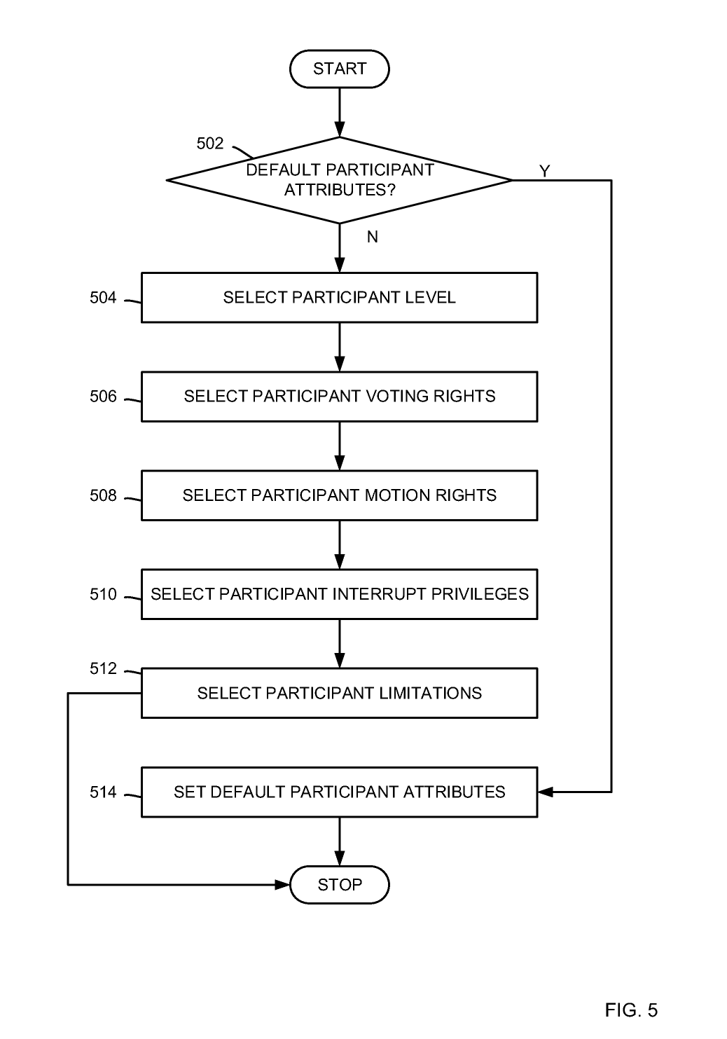

FIG. 3 is an illustrative flowchart 300 of organizing a meeting utilizing methods for conducting an electronic device enhanced meeting using an electronic computing device in accordance with embodiments of the present invention. In particular, flowchart 300 is further illustrative of a step 202 of FIG. 2. As illustrated, at a step 302 methods create a meeting. Generally, a meeting may include meeting attributes, participants, and participant attributes. In creating a meeting, various choices and options may be provided to a user that characterize the desired meeting. Utilizing methods herein, any logged-in user may create a meeting who then becomes the owner/administrator of the meeting. The creator may also select other users to assign or remove administrator rights on a dynamic basis anytime throughout the meeting cycle. In some examples, default selections may be made to assist a user in creating meetings. Those default selections may be easily modified to provide a custom meeting tailored to a specific need or function. At a next step 304, methods select meeting attributes. Meeting attributes provide desired functionality and characterization of a meeting. Selecting meeting attributes will be discussed in further detail below for FIG. 4. At a next step 306, methods select participants. In embodiments, participants may be invited or non-invited. Invited participants may include individuals who are required for a meeting or who have specific reasons for attending a meeting. Non-invited participants are those participants who are not specifically invited, but who may join a meeting as a guest with corresponding guest privileges. For example, in public meetings, members of the public may not be specifically invited, but may, nevertheless, participate by attending in an ad hoc manner. In embodiments, participant attributes of non-invited participants may be dynamically and individually modified during the electronic device enhanced meeting. In embodiments, participants may be locally or remotely available for a meeting utilizing methods provided herein. At a next step 308, methods select participant attributes. Selection of participant attributes will be discussed in further detail below for FIG. 5

FIG. 4 is an illustrative flowchart 400 of establishing meeting attributes utilizing methods for conducting an electronic device enhanced meeting using an electronic computing device in accordance with embodiments of the present invention. In particular, flowchart 400 is further illustrative of a step 304 of FIG. 3. As illustrated, at a step 402, methods select a meeting type. In embodiments, different meeting types may include without limitation: a parliamentary procedure supported meeting, a roundtable meeting, a board meeting, a committee meeting, a teleconference meeting, a lecture meeting, a sporting event, and a concert. In some embodiments, creating a meeting consists of filling in a set of form fields and toggling selectors for various attributes which govern how methods function for that specific meeting based on a specific set of selected or default attributes. For example if the meeting type is set to a parliamentary procedure supported meeting, methods may default to displaying and following an agenda in order as entered during the meeting's creation. However, if the meeting type is set to a roundtable meeting, methods may not display agenda items, may disable motions, and may default primarily to supporting request to speak and to vote functions in any order. As such, at a next step 404, methods determine whether to set default meeting attributes based on meeting type. If methods determine at a step 404 to set default meeting attributes based on meeting type, methods continue to a step 422 to set default meeting attributes based on meeting type whereupon the method ends. Default meeting attributes may, in some embodiments, include: agenda attributes, speaker attributes, meeting security attributes, listing attributes, participant attributes, motion rights attributes, voting rights attributes, and chat attributes. If methods determine at a step 404 not to set default meeting attributes based on meeting type, methods continue to a step 406 to select agenda attributes. In some embodiments, a user may decide to enter no agenda at a step 406. Agenda attributes may include any number of attributes known in the art without departing from embodiments provided herein.

At a next step 408, methods select speaker attributes. Speaker attributes may include speaker times, speaker biographical information, speaker rights and the like without limitation. In some embodiments, a speaker may be given additional rights such as administrative rights or owner rights. These rights may, in embodiments, be added or removed before or during a meeting. At a next step 410, methods select meeting security attributes. It may be useful to establish meeting security attributes that reflect the meeting type. For example, in embodiments, a number of meeting security attributes may be selected such as, a private meeting attribute, a public meeting attribute, a geographically defined meeting attribute, a third party authenticated meeting attribute, an organizationally defined meeting attribute, a viewing only meeting attribute, a password protected meeting attribute, a software secured meeting attribute, and a hardware secured meeting attribute. In addition, any number of meeting security attributes may be utilized in combination. For example, in embodiments, a private meeting attribute may be combined with a hardware secured meeting attribute in combination with near field communication (NFC) tags or quick response (QR) codes. In another example, a geographically defined meeting attribute may limit meeting participation to proximity with a particular geographical location coupled with a password protected meeting attribute that requires a password to attend the meeting. Importantly, in embodiments, meeting security attributes may be separately configured and controlled from any other attribute during a meetings.

At a next step 412, methods select listing attributes. Listing attributes determine how participants are displayed. For example, embodiments may display a dynamic list of meeting participants, viewers, employees, members of the public, or other interested parties who place themselves into the list or who are placed into the list by a meeting administrator. Users may be added by touching a screen with a finger, stylus, mouse or similar pointing device. The list may be dynamically updated in real-time based on a time sequence of each request and further sorted by attributes assigned-to or self-selected for each user. The list may be utilized to create a request to speak queue or any other queue desired by a user. At a next step 414, methods select invitee attributes. In embodiments invitee attributes may include invited participants and non-invited participants. Invited participants are participants specifically invited to attend a meeting created utilizing embodiments provided herein. Non-invited participants are participants that may attend a meeting, but are not otherwise invited to attend a meeting created utilizing embodiments provided herein. For example, during a public city council meeting, a non-invited participant may join a meeting without invitation and be assigned various participation attributes commensurate with a non-invited participant. In this way, public attendance may be encouraged without unduly jeopardizing the orderly conduct of an on-going meeting.

At a next step 416, methods select motion rights attributes. Motions are particularly useful in meetings that support parliamentary procedure, however, motions may be also useful in a variety of meeting types. At a next step 418, methods select voting rights attributes. Voting may proceed in any of a variety of manners. For example, voting may be initiated by a speaker, by an agenda item, by motion, or by any other method desired and may be displayed proactively or just-in-time. In addition, voting may be fulfilled in a variety of manners. In embodiments, voting may proceed by a yes, no, or abstain option. In addition, voting may proceed by selection from a variety of choices such as selecting from a list. In some embodiments, a voting countdown timer may be enabled and configured to display during voting. When a voting countdown timer expires, a tally may be immediately made and displayed or tallied later and kept private. Tallies may be distributed in any number of manners such as displayed via a user interface, via text message, via email, or via any other manner known in the art without departing from embodiments provided herein. In some instances voting may be anonymous.

At a next step 420, methods select chat attributes. If enabled by the meeting administrator a chat room may become available during an active meeting. Messages entered in the chat room may be instantly displayed for all users to view and scrolled on the available screen space in a reverse chronological order. In some instances private chats may be configured as well as group chats that include a subset of meeting members that may be private, public, or publically anonymous. The method then ends.

FIG. 5 is an illustrative flowchart of establishing participant attributes utilizing methods for conducting an electronic device enhanced meeting using an electronic computing device in accordance with embodiments of the present invention. In particular, flowchart 500 is further illustrative of a step 308 of FIG. 3. At a first step 502, methods determine whether to set default participant attributes. If methods determine at a step 502 to set default participant attributes, methods continue to a step 514 to set default participant attributes whereupon methods end. Default participant attributes may be useful for configuring non-invited participants. For example, when a non-invited participant joins a meeting, default participant attributes ensure that minimal disruption of an on-going meeting occur. In embodiments, default participant attributes may be applied to any participant without limitation. If methods determine at a step 502 not to set default participant attributes, methods continue to a step 504 to select participant levels. In embodiments, participants may be administrators capable of configuring and reconfiguring aspects of a meeting or may simply be non-invited guest who may attend but not otherwise participate in a meeting. Methods provided herein allow for the promotion of users into a unique level (or class) whereby certain actions such as voting are limited. Promoted users may be granted other preferences such as front-of-the-line in the speaker queue. For example, in an embodiment, an administrator may promote several users to a voting unlimited level and others to a voting limited level. Users in the voting unlimited level may vote on any voting topic, while users in the voting limited level may vote only on subject matter related voting topics. Any number of levels may be selected such as, subject matter level, organizational hierarchy level, management level, seniority level, or any other administrator selected criteria without departing from embodiments provided herein. Other preferences may be provided by level or individually without limitation such as for example, front-of-the-line speaker, interruption priority, comment limitations and the like without departing from embodiments provided herein.

At a next step 506, methods select participant voting rights. It may be desirable to limit voting to a particular set of meeting participants. For example, in a board meeting, it may be desirable to limit voting to active board members in a particular committee. Voting may be restricted in any manner without departing from embodiments provided herein. At a next step 508, methods select participant motion rights. It may be desirable to limit a participants ability to make motions. Motion rights may be granted or limited before or during a meeting. In addition, motion rights may be limited based on subject matter or agenda items. For example, a participant may have motion rights on one agenda matter, but not on another. In this manner, a complex meeting may be conducted in an orderly and effective manner.

At a next step 510, methods select participant interrupt privileges. Interrupt privileges allow a participant, in prescribed circumstances, to interrupt a meeting or speaker. A participant interrupting a speaker may, for example, be entered into a queue. In another example, a participant interrupting a speaker may, for example override the speaker and take the floor. At a next step 512, methods select participant limitations. It may be desirable to specifically limit a participant's ability to interact in a meeting. For example, a witness may be limited to respond to specific agenda items, but precluded from interrupting a speaker or other witness. In other embodiments, methods may further optionally select a participant display name and a participant display image. It is important to note that all participant attributes may be selected before or during a meeting. In this way, dynamic control of the participant's meeting behavior may be effectively moderated to improve a meeting's effectiveness.

FIG. 6 is an illustrative flowchart 600 of running a meeting utilizing methods for conducting an electronic device enhanced meeting using an electronic computing device in accordance with embodiments of the present invention. In particular, flowchart 300 is further illustrative of a steps 204 and 208 of FIG. 2. At a first step 602, methods run an agenda. Running an agenda is one method for conducting a meeting in an orderly manner. However, methods are not limited to running an agenda to conduct a meeting. In some meeting types, no agenda is used. The following steps are presented in no particular order to clarify functionality of embodiments disclosed herein. As such, no limitation with respect to order or combination should be construed or implied. At a step 604, methods determine whether to process a motion. If methods determine at a step 604 to process a motion, methods process the motion at a step 606. If methods determine at a step 604 not to process a motion, methods proceed to a step 608 to determine whether to process a vote.

If methods determine at a step 608 to process a vote, methods process the vote at a step 610. As noted above, Voting may proceed in any of a variety of manners. For example, voting may be initiated by a speaker, by an agenda item, by motion, or by any other method desired and may be displayed proactively or just-in-time. In addition, voting may be fulfilled in a variety of manners. In embodiments, voting may proceed by a yes, no, or abstain option. In addition, voting may proceed by selection from a variety of choices such as selecting from a list. In some embodiments, a voting countdown timer may be enabled and configured to display during voting. When a voting countdown timer expires, a tally may be immediately made and displayed or tallied later and kept private. Tallies may be distributed in any number of manners such as displayed via a user interface, via text message, via email, or via any other manner known in the art without departing from embodiments provided herein. In some instances voting may be anonymous.

If methods determine at a step 608 not to process a vote, methods proceed to a step 612 to determine whether to process an interruption. If methods determine at a step 612 to process an interruption, methods process the interruption at a step 614. Methods provide for displaying a dynamic list of meeting participants, viewers, employees, members of the public, or other interested parties who place themselves into a request to speak queue (i.e. an interruption) or who may be placed into the queue by a meeting administrator. Users may be added by touching a screen with a finger, stylus, mouse or similar pointing device. The list may be dynamically updated in real-time based on a time sequence of each request and further sorted by attributes assigned-to or self-selected for each user. If methods determine at a step 612 not to process an interruption, methods proceed to a step 616 to determine whether to modify a participant.

If methods determine at a step 616 to modify a participant, methods modify a participant at a step 618 whereupon methods continue to a step 620. As noted above, methods provided herein allow for the promotion of users into a unique level (or class) whereby certain actions such as voting are limited. Modified users may be granted other preferences such as front-of-the-line in the speaker queue. For example, in an embodiment, an administrator may modify several users to a voting unlimited level and others to a voting limited level. Users in the voting unlimited level may vote on any voting topic, while users in the voting limited level may vote only on subject matter related voting topics. Any number of levels may be selected such as, subject matter level, organizational hierarchy level, management level, seniority level, or any other administrator selected criteria without departing from embodiments provided herein.

If methods determine at a step 616 not to modify a participant, methods proceed to a step 620 to update and display minutes. In embodiments, meeting actions may be automatically captured as minutes. For example, on-going summary meeting minutes may be updated in real-time and immediately available for publication or distribution as meetings happen. As another example, during a meeting, users make themselves heard via actions signaled from within the application, such as speaking, recording motions and voting. The actions of all users are then displayed in a single list within the application or may be subscribed to and disseminated either as the meeting is ongoing or after the meeting has ended. The subscriptions may be distributed via technology of the users choice such as text messaging, email, social networks and blogs. The list may be sorted and viewed chronologically, by user and by action. In some embodiments, recorded minutes may be appended with a representative portion or sample of a recorded audio clip, video clip, or audio/video clip that corresponds with the recorded minutes and is accessible through the recorded minutes. In this manner, a person reviewing minutes may quickly and easily reacquaint themselves with the context in which the minutes were recorded. At a next step 622, methods determine whether to end a meeting. If methods determine at a step 612 to end a meeting, methods end the meeting. If methods determine at a step 622 not to end the meeting, methods continue to a step 602 to run the agenda. Once a meeting has ended, minutes may be distributed via any suitable manner known in the art.

Device Specific Versions

Embodiments may be configured to conform to a specific device having specific operational parameters such as, for example, screen size, memory constraints, data transfer limitations, and the like. The operational parameters may be entered by each user, by the administrator, or through a database automatically.

Dual Server/Application Communications

Methods may utilize systems for communicating changes and or updates initiated via one user or automatically initiated by the host server which must then be communicated to or and broadcast to each additional user engaged in the same meeting. Users may join, exit and rejoin a meeting at any time. Joining and rejoining may occur due to the deliberate actions of the user or may occur if the user were to lose connection to the server due to, for example, a poor network signal or a users device software crash. Methods disclosed herein provided for a resilient system to update each users device with the most recent meeting changes.

Pull Technology

When running in ‘pull’ mode methods make a request to a server every X seconds (for example 10 seconds). In this request, an encrypted token may be passed to the server which contains state information that indicates to the server what state methods are in, and what the last known information received from the server was. The server then takes this state information and determines what information has changed and passes back the necessary updates in order to bring methods to a current state. As such, methods receive a response from a server with all the updated information and updates itself as needed.

Push Technology

When running in ‘push’ mode methods make a hi-directional WebSocket connection to a server for each meeting a user joins. WebSocket is a protocol providing full-duplex communications channels over a single TCP connection. This socket connection is kept open as long as the user is in the meeting and it is kept and active/speedy via occasional ‘ping’ and ‘ack’ requests. When an action is performed in a meeting, the server makes the necessary updates to the database, and then pushes out the update information to all users actively connected to the meeting. As such, methods receive a real-time notification of a meeting update from the push server and updates the application view as needed.

Push/Pull Auto-Switching

Methods initially begin running in ‘push’ mode since the updates are real-time. If at some point methods detect that methods are no longer connected to the ‘push’ service, then methods may automatically fail over into ‘pull’ mode. While running in ‘pull’ mode, methods may occasionally attempt to re-establish a WebSocket connect to the push service, and if successfully able to connect, methods may automatically switch back to ‘push’ mode. A user may also choose to force methods into either ‘push’ or ‘pull’ mode and methods will continue using that mode until it detects a failure, and then methods may attempt to failover to an alternate mode.

While this invention has been described in terms of several embodiments, there are alterations, permutations, and equivalents, which fall within the scope of this invention. It should also be noted that there are many alternative ways of implementing the methods, computer program products, and apparatuses of the present invention. Furthermore, unless explicitly stated, any method embodiments described herein are not constrained to a particular order or sequence. Further, the Abstract is provided herein for convenience and should not be employed to construe or limit the overall invention, which is expressed in the claims. It is therefore intended that the following appended claims be interpreted as including all such alterations, permutations, and equivalents as fall within the true spirit and scope of the present invention.

What is claimed is:

1. A method for conducting an electronic device enhanced meeting using an electronic computing device, the method comprising:
causing the electronic computing device to create the electronic device enhanced meeting;
selecting meeting attributes for the electronic device enhanced meeting;
selecting participants for the electronic device enhanced meeting;
selecting participant attributes for the electronic device enhanced meeting; and
conducting the electronic device enhanced meeting.

2. The method of claim 1, wherein selecting meeting attributes for the electronic device enhanced meeting further comprises:
selecting a meeting type; and
setting default meeting attributes, wherein the default meeting attributes are selected from the group consisting of: agenda attributes, speaker attributes, meeting security attributes, listing attributes, invite attributes, motion rights attributes, voting rights attributes, and chat attributes.

3. The method of claim 2, wherein selecting meeting attributes for the electronic device enhanced meeting further comprises:
selecting agenda attributes;
selecting speaker attributes;
selecting meeting security attributes; and
selecting listing attributes.

4. The method of claim 2, wherein selecting meeting attributes for the electronic device enhanced meeting further comprises:
selecting invite attributes, wherein the invite attributes include invited participants and non-invited participants;
selecting motion rights attributes;
selecting voting rights attributes; and
selecting chat attributes.

5. The method of claim 2, wherein the meeting type is selected from the group consisting of: a parliamentary procedure supported meeting, a roundtable meeting, a board meeting, a committee meeting, a teleconference meeting, a lecture meeting, a sporting event, and a concert.

6. The method of claim 3, wherein the meeting security attributes for the electronic device enhanced meeting are selected from the group consisting of: a private meeting attribute, a public meeting attribute, a geographically defined meeting attribute, a third party authenticated meeting attribute, an organizationally defined meeting attribute, a viewing only meeting attribute, a password protected meeting attribute, and a hardware secured meeting attribute.

7. The method of claim 4, wherein participant attributes of non-invited participants may be dynamically and individually modified during the electronic device enhanced meeting.

8. The method of claim 1, wherein selecting participant attributes for the electronic device enhanced meeting further comprises:
selecting a participant level;
selecting participant motion rights;
selecting participant voting rights;
selecting participant interrupt privileges;
selecting participant limitations;
selecting participant display name; and
selecting participant display image.

9. The method of claim 8, wherein the participant attributes for the electronic device enhanced meeting may be dynamically and individually modified during the electronic device enhanced meeting.

10. The method of claim 1, wherein conducting the electronic device enhanced meeting further comprises:
running the agenda; and
automatically updating and displaying minutes in response to actions associated with running the agenda.

11. The method of claim 10, wherein conducting the electronic device enhanced meeting further comprises:
processing a motion;
processing a vote;
processing an interruption; and
modifying a participant.

12. The method of claim 10, wherein conducting the electronic device enhanced meeting further comprises:
modifying the participant attributes.

13. A computing device program product for conducting an electronic device enhanced meeting using a computing device, the computing device program product comprising:
a non-transitory computer readable medium;
first programmatic instructions for creating the electronic device enhanced meeting wherein the programmatic instructions are stored on the non-transitory computer readable medium;
second programmatic instructions for selecting meeting attributes for the electronic device enhanced meeting;
third programmatic instructions for selecting participants for the electronic device enhanced meeting;
fourth programmatic instructions for selecting participant attributes for the electronic device enhanced meeting; and
fifth programmatic instructions for conducting the electronic device enhanced meeting.

14. The computing device program product of claim 13, wherein second programmatic instructions for selecting meeting attributes for the electronic device enhanced meeting further comprises:
sixth programmatic instructions for selecting a meeting type; and
seventh programmatic instructions for setting default meeting attributes, wherein the default meeting attributes include at least agenda attributes, speaker attributes, meeting security attributes, listing attributes, invite attributes, motion rights attributes, voting rights attributes, and chat attributes.

15. The computing device program product of claim 14, wherein the meeting type is selected from the group consisting of: a parliamentary procedure supported meeting, a roundtable meeting, a board meeting, a committee meeting, a teleconference meeting, a lecture meeting, a sporting event, and a concert.

16. The computing device program product of claim 14, wherein the second programmatic instructions for selecting meeting attributes for the electronic device enhanced meeting further comprises:
eighth programmatic instructions for selecting meeting security attributes, wherein the meeting security attributes for the electronic device enhanced meeting are selected from the group consisting of: a private meeting attribute, a public meeting attribute, a geographically defined meeting attribute, a third party authenticated meeting attribute, an organizationally defined meeting attribute, a viewing only meeting attribute, a password protected meeting attribute, a software secured meeting attribute, and a hardware secured meeting attribute.

17. The computing device program product of claim 13, wherein the participant attributes for the electronic device enhanced meeting may be dynamically and individually modified during the electronic device enhanced meeting.

18. The computing device program product of claim 13, wherein the fifth programmatic instructions for conducting the electronic device enhanced meeting further comprises:
ninth programmatic instructions for running the agenda; and
tenth programmatic instructions for automatically updating and displaying minutes in response to actions associated with running the agenda.

19. The computing device program product of claim 18, wherein the fifth programmatic instructions for conducting the electronic device enhanced meeting further comprises:
eleventh programmatic instructions for processing a motion;
twelfth programmatic instructions for processing a vote;
thirteenth programmatic instructions for processing an interruption; and
fourteenth programmatic instructions for modifying a participant.
